(19) United States
(12) Patent Application Publication
(10) Pub. No.: US 2009/0255419 A1
(43) Pub. Date: Oct. 15, 2009

(54) METHOD AND APPARATUS FOR MAKING A FLAKY MEAT PRODUCT

(76) Inventor: Sam A. Kirsch, Oklahoma City, OK (US)

Correspondence Address: DUNLAP CODDING, P.C., PO BOX 16370, OKLAHOMA CITY, OK, 73113, US

(21) Appl. No.: 12/491,100

(22) Filed: Jun. 24, 2009

Related U.S. Application Data
(63) Continuation of application No. 11/341,698, filed on Jan. 27, 2006, now abandoned.
Application No. 11/341,698 is a division of application No. 10/289,778, filed on Nov. 8, 2002, now abandoned.

(51) Int. Cl. A47J 43/00; F25D 11/00; F25D 25/04

(52) U.S. Cl. 99/538; 62/440; 62/380

(57) ABSTRACT

A device for producing a tenderized meat loaf Meat is separated from hide and bone, and cut into small pieces which are thermally homogenized to a freezing temperature. The pieces of meat are compressed into a meat bale which is then sliced into slices greater than 0.6 millimeters in thickness. The slices are collected and vacuum extruded into meat loaf product which may be processed and handled at a temperature approximating freezing, without substantial risk of inadvertent cleavage or destruction of the meat loaf. Due to the laminate construction, the final meat product forms an integral piece of meat which has a high degree of resulting tenderness and a high quality texture.

### CROSS-REFERENCE TO RELATED APPLICATIONS

The present application is a continuation of U.S. Ser. No. 11/341,698, filed Jan. 27, 2006, which is a divisional of U.S. Ser. No. 10/289,778, filed Nov. 8, 2002, now abandoned, which are hereby expressly incorporated by reference herein in their entirety.

### BACKGROUND OF INVENTION

This invention relates to a method and apparatus for producing a flaky meat bale and, more specifically, to a method and apparatus for producing large quantities of substantially homogenous tender meat product from less tender cuts of meat.

### DESCRIPTION OF THE PRIOR ART

It is known in the art to tenderize tough cuts of meat by grinding, slicing, scoring, poking or crushing the meat. One drawback associated with this process is the inefficiency associated with tenderizing the interior of thick cuts of meat. Additional drawbacks include the over tenderization of more tender parts of a variegated piece of meat, and under tenderization of tougher parts of the meat. It is known in the art to grind meat into hamburger. The drawback associated with this process involves the resulting consistency of hamburger. Although the resulting hamburger is tender and uniform, the final product has neither the consistency nor appearance of tender, whole muscle meat. It is also known in the art to cut tough cuts of meat into thin slices, and then attempt to bind the resulting slices into a finished meat product. These prior art methods, however, involve methods and apparatuses difficult to adapt to large scale efforts in production of a flaky meat product. These processes often result in fragile, runny or tough product. The difficulties described hereinabove are substantially eliminated by the present invention.

### SUMMARY OF THE INVENTION

In an advantage provided by this invention, a method and apparatus is provided for producing a meat product with an appearance similar to whole muscle meat. Advantageously, this invention provides a method and apparatus for producing a meat product with the consistency of whole muscle meat. Advantageously, this invention provides a method and apparatus for producing a meat product with the flavor of whole muscle meat. Advantageously, this invention provides a method and apparatus for automatically flavorizing a flaky meat product. Advantageously, this invention provides a method and apparatus for adding moisture to a flaky meat product. Advantageously, in a preferred embodiment of this invention, a device for producing a meat product is provided. The device includes a cooler for homogenizing meat to a temperature below freezing, and means for moving the meat to a press, capable of compressing the meat into a bale. A slicer is provided for slicing the bale into slices between 0.6 and 1.8 millimeters in thickness. Means are also provided for maintaining the meat below freezing during slicing, and for moving the meat from the slicer to a compressor. The compressor compresses meat slices in a manner which forms a substantially integral body. In the preferred embodiment, the meat bale is preferably brought to a substantially homogenous temperature, sliced, and then combined with a flavor enhancer. Also, the compressor, preferably a double-screw extruder, compresses the slices, while substantially maintaining their integrity, to produce an integral flaky meat product.

### BRIEF DESCRIPTION OF THE DRAWINGS

The present invention will now be described, by way of example, with reference to the accompanying drawings in which:

FIG. 1 illustrates a top plan view of the flaky meat forming apparatus of the present invention;

FIG. 2 illustrates a top plan view of the apparatus of FIG. 1, shown with the meat being formed into a bale;

FIG. 3 illustrates the apparatus of FIG. 1, shown with the meat bale being increased in size;

FIG. 4 illustrates the apparatus of FIG. 1, shown with the meat bale completely formed; FIG. 5 illustrates a front elevation of the cutting blades and cutting guard of the present invention; and

FIG. 5 illustrates a side elevation in partial cross-section of the rotating slicer, slicing a meat bale and the leaves being sprayed prior to compression in the dual screw extruder.

### DETAILED DESCRIPTION OF THE PREFERRED EMBODIMENT

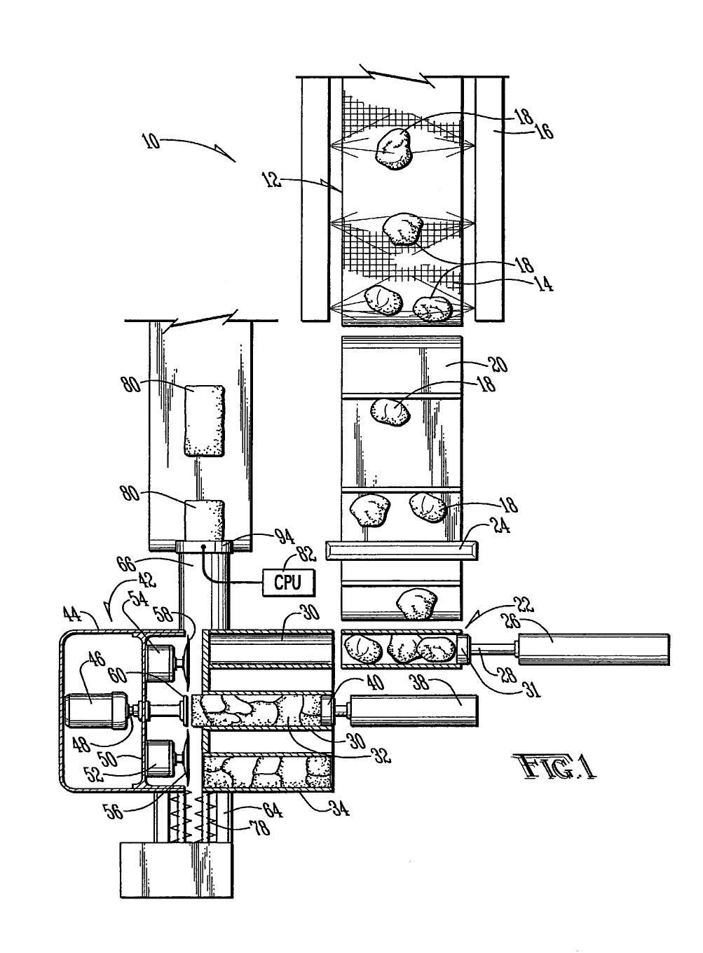

With reference to the drawings, an improved leaf meatloaf production apparatus is shown generally as (10) in FIG. 1. The apparatus (10) is preferably provided with a first conveyor (12) provided with a mesh surface (14). The conveyor (12) preferably passes through a carbon dioxide spiral freezer (16), directing a sufficient quantity of cool carbon dioxide across the conveyor (12). The freezer, of course, may be a single or triple pass tunnel freezer, an ammonia freezer, or any other type of freezer known in the art. This process homogeneously cools meat pieces (18) moving across the conveyor (12) to a predetermined temperature. Preferably, this temperature is within 5 degrees Fahrenheit of freezing, more preferably below freezing, and most preferably, between twenty and thirty degrees Fahrenheit. The spiral freezer (16) will quickly drop the temperature of the meat pieces (18) to approximately twenty to thirty degrees Fahrenheit, and ultimately equalize the internal temperature of the meat pieces (18) to a temperature preferably below freezing, more preferably between twenty-six and thirty degrees Fahrenheit, and most preferably, about twenty-eight degrees Fahrenheit. The temperature of meat pieces (16) preferably varies by no more than five degrees Fahrenheit, more preferably, by no more than two degrees Fahrenheit, and most preferably, by no more than one degree Fahrenheit across its body.

The speed and length of the conveyor (12), the temperature and volume of the spiral freezer (16), and size and type of the meat pieces (18) are all coordinated to achieve this preferred homogeneity of temperature in the meat pieces (18) by the time the meat pieces (18) reach the end of the conveyor (12). Preferably, the meat pieces (18) are slabs approximately three and one-half to five and one-half centimeters thick. The thickness may be adjusted for speed and meat type to obtain homogenous cooling. The meat pieces (18) may, of course, be of any suitable size or dimensions. The meat pieces (18) are preferably separated from bone, hide and other undesirable materials prior to placement on the conveyor (12).

If desired, moisture enhancements may be injected into the meat prior to placement on the conveyor (12). Such moisture enhancements may contain any type of known flavor profiles and are preferably delivered in a brine solution. Such moisture enhancements preferably comprise no more than twenty percent by weight of beef and lamb meat pieces (18), and thirty percent by weight of pork or poultry meat pieces (18). Once the meat pieces (18) have reached a substantial equilibrium temperature of approximately twenty-eight degrees Fahrenheit throughout their respective volumes, the meat pieces (18) move onto a second conveyor (20) which raises the meat pieces (18) toward a hopper (22). The second conveyor (20) need not elevate the meat pieces (18), and may even be eliminated if it is desired to move the meat pieces (18) directly from the conveyor (12) to the hopper (22). As shown in FIG. 1, provided across the second conveyor (20) is a metal detector (24). The metal detector (24) is of a type known in the art to detect small pieces of metal or shavings contained within the meat pieces (18). The metal detector (24) is preferably electronically coupled to the second conveyor (20) so as to cause the second convey (20) to stop upon detection of metal within any of the meat pieces (18). Ambient temperature for additional cooling equipment is provided as necessary to maintain the thermal homogeneity of the meat pieces (18) as they move from the conveyor (12) to the hopper (22).

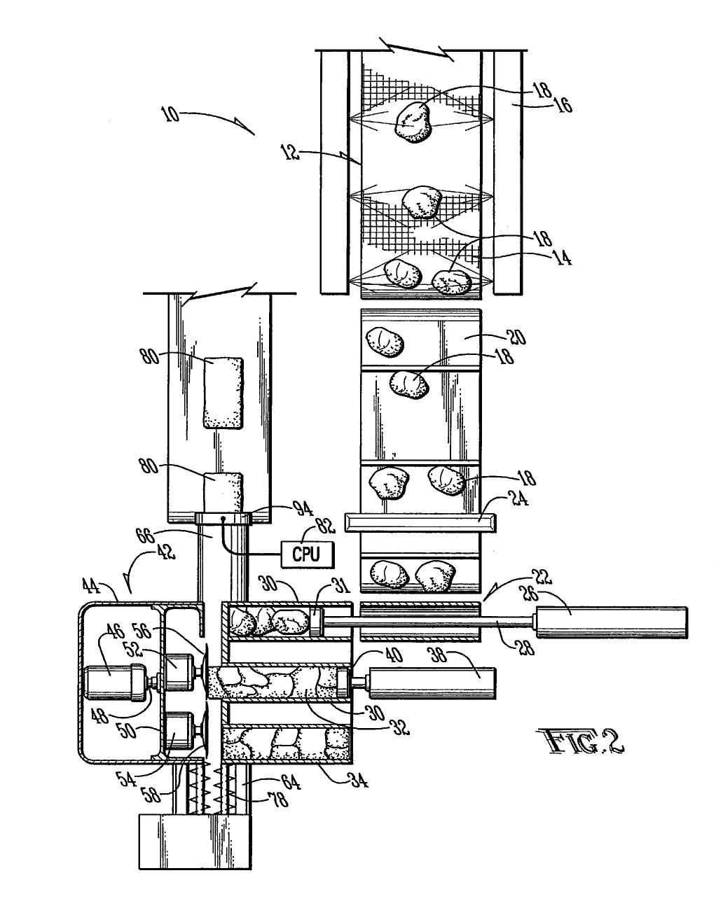

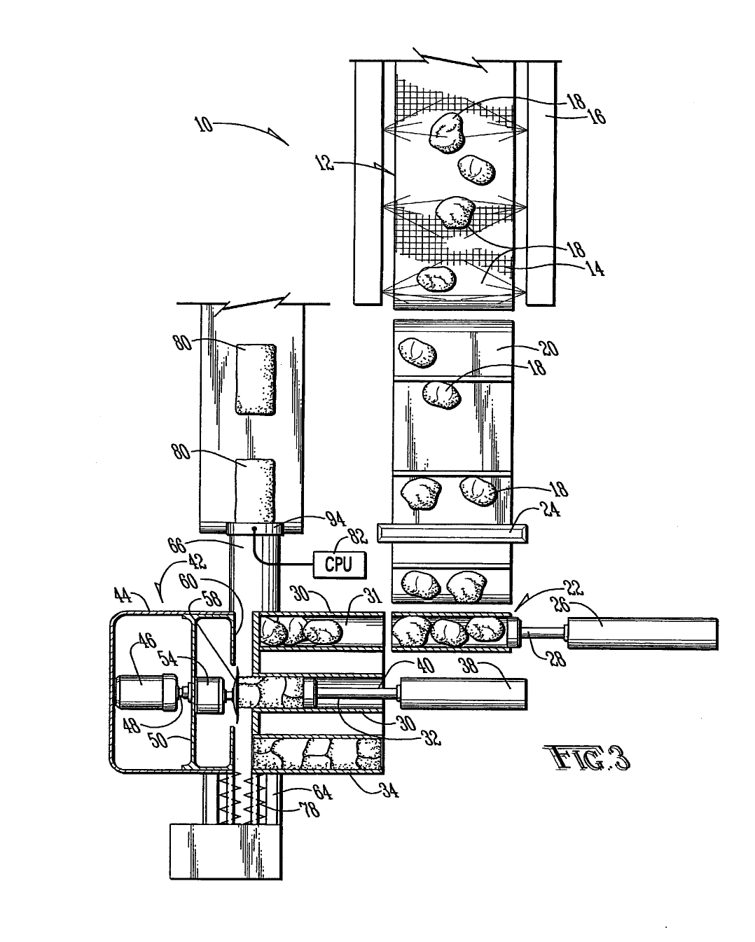

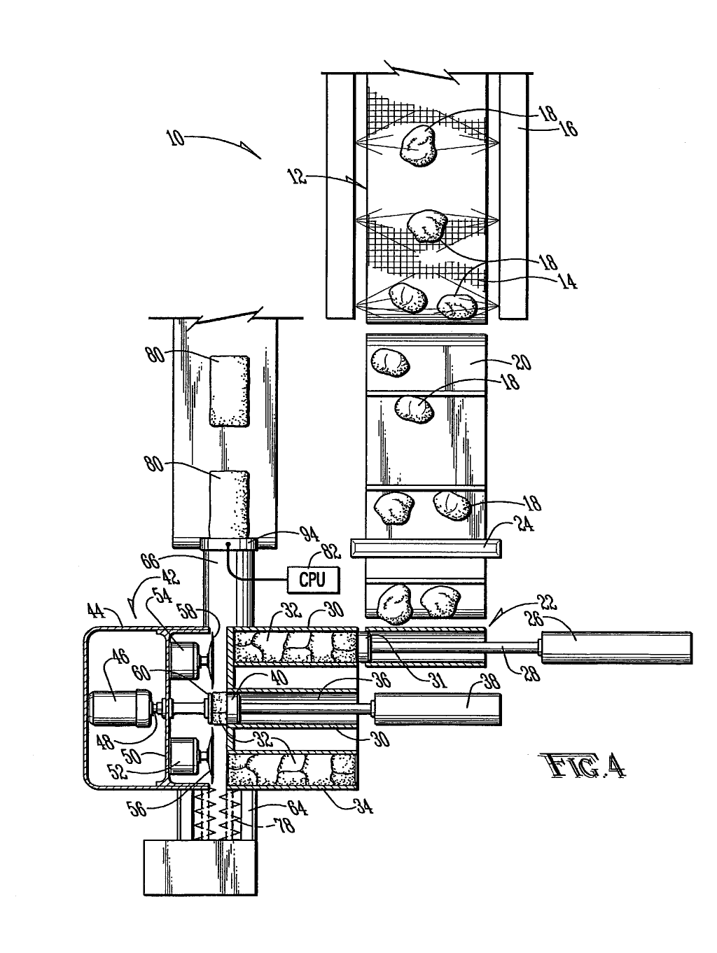

Once a predetermined volume of meat pieces (18) has entered the hopper (22), a linear actuator (26) actuates a piston (28) to drive the meat pieces (18) into a barrel (30) of a predetermined length and a diameter, substantially similar to that of the head (31) of the piston (28). As shown in FIG. 2, the linear actuator (26) continues to actuate until the appropriate pressure has been applied to compact the meat pieces (18). The pressure applied is preferably between four hundred and fifteen hundred pounds per square inch, and more preferably, between six hundred and one thousand pounds per square inch. Tender meats such as pork and chicken fiber tend to require less pressure than beef or similar types of meat. Applying the pressure to the meat pieces (18) will be associated with a thermal change in the meat pieces (18), assisting in equalization of temperature across the meat pieces (18). It is preferred that the meat bale (32) formed as the result of the compaction be cooled below freezing, preferably to a temperature between fourteen and twenty-eight degrees Fahrenheit. Once the appropriate pressure has been applied to the bale (32), as shown in FIG. 3, the linear actuator (26) retracts the piston (28) and another predetermined volume of meat pieces (18) is supplied to the hopper (22) by the second conveyor (20). Once the predetermined volume has been received in the hopper (22), as shown in FIG. 4, the linear actuator (26) actuates the piston (28) to pressurize the meat pieces (18) and finalize construction of the bale (32). Once the bale (32) has been fully constructed, the linear actuator (26) retracts the piston (28) and the cylinder (34) which houses the barrel (30) rotates to present an empty barrel (36) to the linear actuator (26). The completed bale (32) will then continue to be cooled and rest in the barrel (30) to achieve thermal homogeneity.

After the bale (32) has been cooled for the desired amount of time to reach thermal homogeneity, the cylinder (34) is then rotated to present the bale to a second linear actuator (38) as shown in FIG. 1. As shown in FIG. 1, once the bale (32) has been presented to the second linear actuator (38), the second linear actuator (38) actuates a second piston (40) to move the bale (32) toward the slicing assembly (42). As shown in FIG. 1, the slicing assembly (42) comprises a cylindrical housing (44) constructed of steel or similarly rigid material. Provided within the housing (44) is a master motor (46). The master motor (46) is provided with a drive shaft (48) coupled to a support bracket (50). Bolted or otherwise secured to the support bracket (50) are a first slicing motor (52) and a second slicing motor (54). Coupled to the slicing motor (52) is a first slicing blade (56), and coupled to the second slicing motor (54) is a second slicing blade (58). The blades (56) and (58) are preferably circular. As shown in FIG. 1, surrounding the blades (56) and (58) is a cutting guard (60).

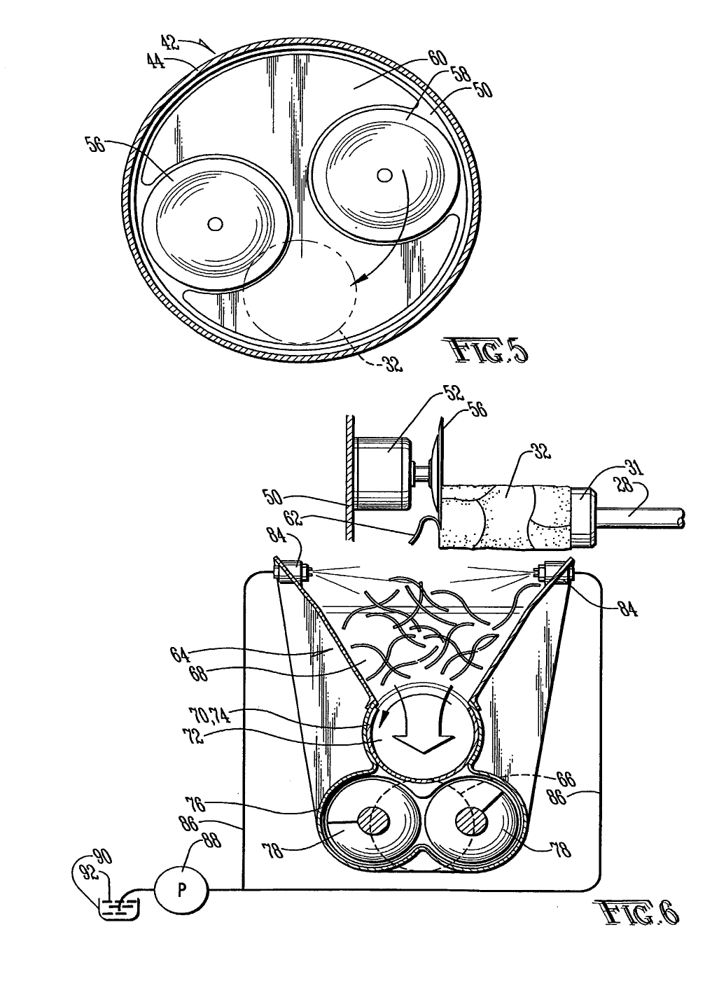

FIG. 5 illustrates a front elevation of the blades (56) and (58) orientated relative to the cutting guard (60). Preferably, the distance between the cutting guard (60) and the blades (56) and (58) is adjustable to a high degree of precision, capable of allowing the cutting blades (56) and (58), and cutting guard (60) coact to cut slices of meat to a uniform thickness, preferably within one millimeter variance across the surface, more preferably 0.5 millimeters across the surface, and most preferably, within 0.1 millimeter across the surface. The slicing assembly (42) may be of a Ross type with revolving blades as described above, or may be of a cleaver type, such as a Treif slicer.

The control systems (not shown) for the slicing assembly (42) and an actuator (38) coact to revolve the blades (56) and (58), and the support bracket (50), along with the pressure of the linear actuator (38) to cut slices of a desired thickness. Preferably, in the present invention, meat slices are cut to a uniform thickness within 0.1 millimeter variance to a thickness between 0.6 millimeters and 1.8 millimeters. More preferably, the meat slices are cut to a thickness between 0.8 millimeters and 1.5 millimeters. The slices of meat may be adjusted depending on the density and consistency of the meat pieces (18) and the desired consistency of the finished product.

During slicing, the bale (32) is preferably maintained at a substantially homogeneous temperature, preferably between about twenty four and twenty-eight degrees Fahrenheit.

As shown in FIGS. 2, 3 and 4, as the slicing assembly (42) rotates the blades (56) and (58), the linear actuator (38) pushes the meat bale (32) into the blades (56) and (58), thereby decreasing the size of the bale (32). As the bale (32) is sliced, as shown in FIG. 6, the meat bale (32) is converted into a plurality of slices (62) having dimensions noted above. The slices (62) preferably fall from the bale (32) into a hopper (64) provided over a vacuum extruder (66), such as those well known in the art. If desired, the hopper (64) may be fitted with a plurality of nozzles (84). The nozzles (84) are in turn coupled to a plurality of feed tubes (86) which, in turn, are coupled to a pump (88) and reservoir (90). The reservoir (90) is preferably filled with a brine solution (92) of flavor enhancers and or binders to provide a finished meat product of a desired taste and consistency. Additionally, other materials, including bacon, cheese, lard, flavors, binders and preservatives may be manually or automatically added into the hopper at this stage.

As shown in FIG. 6, as the slices (62) fill the hopper (64), the augers (78) turn, pushing the slices (62) into on another with sufficient pressure to form an integral product comprised of the various slices. The attributes of the resulting meat loaf (80) exiting from the vacuum extruder (66) is not an absolute homogeneous binding of the slices (62), but the slices (62) fuse together under pressure and vacuum to a degree which allows for the manual handling of the meat loaf (80) at temperatures of freezing or below, without the meatloaf (80) cleaving. The vacuum extruder (66) is provided with two chambers with the delivery hopper (64) coupled to the first chamber (68). The first chamber allows for the accumulation of the meat slices (62). When the desired amount of meat slices (62) are delivered to the hopper (64), a sliding door (70) opens at the bottom of the hopper (64), allowing the meat slices (62) to enter the first vacuum chamber (72). The sliding door (70) will then close, creating an air tight seal. The first vacuum chamber (72) is then evacuated whereafter a set of doors (74) provided on the bottom of the first vacuum chamber (72) are opened, allowing the meat slices (62) to fall under vacuum into the second chamber (76) of the vacuum extruder (66). The doors (74) then close, sealing the second chamber (76). In the second chamber (76), the meat slices (62) contact the twin augers (78) under continuous vacuum for processing by vacuum extrusion into a meat loaf. The amount of vacuum and pressure associated with the extruder (66) may be adjusted for various types of meat to obtain optimum binding and forming. Such adjustment may be controlled by a central processing unit (82), or manually adjusted by an operator (not shown). (FIG. 1). The resulting meat loaf (80) may then be sliced or divided as desired. The vacuum extruder (66) may, of course, be fitted with an extrusion horn (94) of any desired dimensions to produce a meat loaf (80) of predetermined dimensional characteristics.

The foregoing description and drawings merely explain and illustrate the invention and the invention is not limited thereto, except insofar as the claims are so limited, as those skilled in the art who have the disclosure before them will be able to make modifications and variations therein without departing from the scope of the invention. For example, it is anticipated that any desired type of meat may be formed into any desired resulting configuration. It is also anticipated that any type of press or cutter may be used to formulate the meat loaf (80).

What is claimed is:

1. A device for producing a meat product comprising:
a cooler comprising means for homogenizing meat to a temperature below freezing;
a press comprising means for compressing meat into a bale;
means for moving meat between said cooler and said press;
a slicer comprising means for slicing meat slices greater than 0.6
millimeter and less than 1.8 millimeter;
means for maintaining meat below freezing during slicing;
a compressor comprising means for compressing meat slices in a matter which forms a substantially integral body; and
means for moving meat slices from said slicer to said compressor.

2. The device for producing a meat product of claim 1, further comprising means for maintaining meat substantially stationary during slicing.

3. The device for producing a meat product of claim 1, wherein said compressing means comprises means for compressing meat under a force at least four hundred pounds per square inch.

4. The device for producing a meat product of claim 1, wherein said cooler comprises means for homogenizing meat to a temperature below twenty-six to thirty degrees Fahrenheit.

5. The device for producing a meat product of claim 1, further comprising a metal detector located upstream from said slicer.

6. The device for producing a meat product of claim 1, further comprising means for injecting moisture into meat prior to slicing.

7. The device for producing a meat product of claim 1, further comprising means positioned between said slicer and said compressing means for adding non-meat flavoring to meat.

8. The device for producing a meat product of claim 1, wherein said maintaining means is means for maintaining meat below thirty degrees Fahrenheit during slicing.

9. The device for producing a meat product of claim 1, wherein said compressor is an extruder.

10. The device for producing a meat product of claim 9, wherein said extruder is a vacuum extruder.

11. The device for producing a meat product of claim 1, further comprising means for supplying a plurality of meat blocks to said slicer in a manner which maintains a substantially constant pressure on meat as it is being sliced by said slicer.

12. An apparatus for producing a flaky meat product comprising:
a cooler comprising means for cooling meat to a substantially homogeneous predetermined temperature, wherein said substantially homogeneous predetermined temperature is a temperature between fourteen and thirty degrees Fahrenheit;
a slicer;
means coupled to said slicer for preventing said slicer from cutting meat slices less than 0.6 millimeter in thickness;
means coupled to said slicer for preventing said slicer from cutting meat slices eater than 1.8 millimeters in thickness;
means for conveying meat from said cooler to said slicer;
means for preventing meat sliced by said slicer from attaining a temperature above freezing;
an extruder comprising means for compressing a plurality of meat slices into a substantially integral body; and
means for conveying meat slices from said slicer to said extruder.

13. The apparatus for producing a flaky meat product of claim 12, wherein said compressing means comprises means for compressing meat under a force at least four hundred pounds per square inch.

14. The apparatus for producing a flaky meat product of claim 12, wherein said cooler comprises means for homogenizing meat to a temperature below twenty-six to thirty degrees Fahrenheit.

15. The apparatus for producing a flaky meat product of claim 12, hither comprising a metal detector provided between said cooler and said slicer.

16. The apparatus for producing a flaky meat product of claim 12, further comprising means for injecting moisture into meat prior to slicing.

17. The apparatus for producing a flaky meat product of claim 12, wherein said extruder is a vacuum extruder.
